(19) United States
(12) Patent Application Publication
(10) Pub. No.: US 2018/0196567 A1
(43) Pub. Date: Jul. 12, 2018

(54) PRESSURE SENSITIVE VIRTUAL KEYBOARD

(71) Applicant: Microsoft Technology Licensing, LLC, Redmond, WA (US)

(72) Inventors: Christian Klein, Duvall, WA (US); Aneetinder Chowdhry, Seattle, WA (US)

(73) Assignee: Microsoft Technology Licensing, LLC

(21) Appl. No.: 15/402,098

(22) Filed: Jan. 9, 2017

(51) Int. Cl. G06F 3/041; G06F 3/0488; G06F 3/023

(52) U.S. Cl. CPC G06F 3/0414; G06F 3/0233; G06F 3/04886

(57) ABSTRACT

Embodiments relate to using pressure features of touch inputs directed to a virtual keyboard to control the symbols outputted by the virtual keyboard. Specifically, when interacting with a virtual keyboard, pressures of physical touches directed to the displayed virtual keyboard are sensed and included with corresponding touch inputs provided to the virtual keyboard. In the process of determining what symbols are outputted by the virtual keyboard, the virtual keyboard considers the pressure features of the touch inputs. A pressure feature of a touch input directed to the virtual keyboard can control which symbol is outputted by activation of a virtual key by the touch input. The pressure can also, or alternatively, trigger outputting of symbols not corresponding to key activations, transforming words or symbols (e.g., capitalizing, selecting diacritics, applying visual effects).

### BACKGROUND

The advent of touch-sensitive displays has led to new ways of enabling users to interact with computing devices. For instance, physical keyboards that signal physical actuation of physical keys have been supplanted by displayed virtual keyboards that signal touch activation of virtual keys. Typically, virtual keyboards loosely mimic physical keyboards and enable a touch display screen to be used to input symbols (e.g., alphanumeric characters, emoji symbols, hanzi, kanji, etc.). While virtual keyboards serve the same function as physical keyboards, there are practical differences. For instance, virtual keyboards are generally slower to use. Virtual keys are often small and tightly packed and the mechanics of typing may differ from the mechanics of typing on a physical keyboard. Due to limited space, some keys may be overloaded with multiple permutations of a character; multiple user steps or interactions may be needed to specify a permutation of a symbol associated with a virtual key. Generally virtual keyboards are less efficient to use due to obvious differences between physical keyboards and virtual keyboards.

Techniques discussed below relate to using sensed pressure of touch inputs directed to virtual keyboards to modify or supplement the symbols that are outputted by the virtual keyboard.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments relate to using pressure features of touch inputs directed to a virtual keyboard to control the symbols outputted by the virtual keyboard. Specifically, when interacting with a virtual keyboard, pressures of physical touches directed to the displayed virtual keyboard are sensed and included with corresponding touch inputs provided to the virtual keyboard. In the process of determining what symbols are outputted by the virtual keyboard, the virtual keyboard considers the pressure features of the touch inputs. A pressure feature of a touch input directed to the virtual keyboard can control which symbol is outputted by activation of a virtual key by the touch input. The pressure can also, or alternatively, trigger outputting of symbols not corresponding to key activations, transforming words or symbols (e.g., capitalizing, selecting diacritics, applying visual effects).

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a computing device configured to provide a user interface on a display.

FIG. 2 shows additional details of the computing device.

FIG. 3 shows context and data flow of the virtual keyboard.

FIG. 4 shows a process by which a virtual keyboard may take into account pressure of touch inputs directed to the virtual keyboard.

FIG. 5 shows examples of using pressure to select an effect or permutation of a symbol.

FIG. 6 shows a process for using both a pressure feature and non-pressure feature of a virtual keyboard touch input.

FIG. 7 shows examples of using pressure and non-pressure touch input parameters to select a symbol.

FIG. 8 shows a process for using pressure to select augmentation symbols that are added to text inputted via the virtual keys.

FIG. 9 shows examples of pressure-guided symbol augmentation.

FIG. 10 shows a process for using pressure to guide how a virtual keyboard selects symbols when performing word-shaping.

FIG. 11 shows examples of word-shaping with pressure-based interaction.

FIG. 12 shows details of a computing device on which embodiments described herein may be implemented.

### DETAILED DESCRIPTION

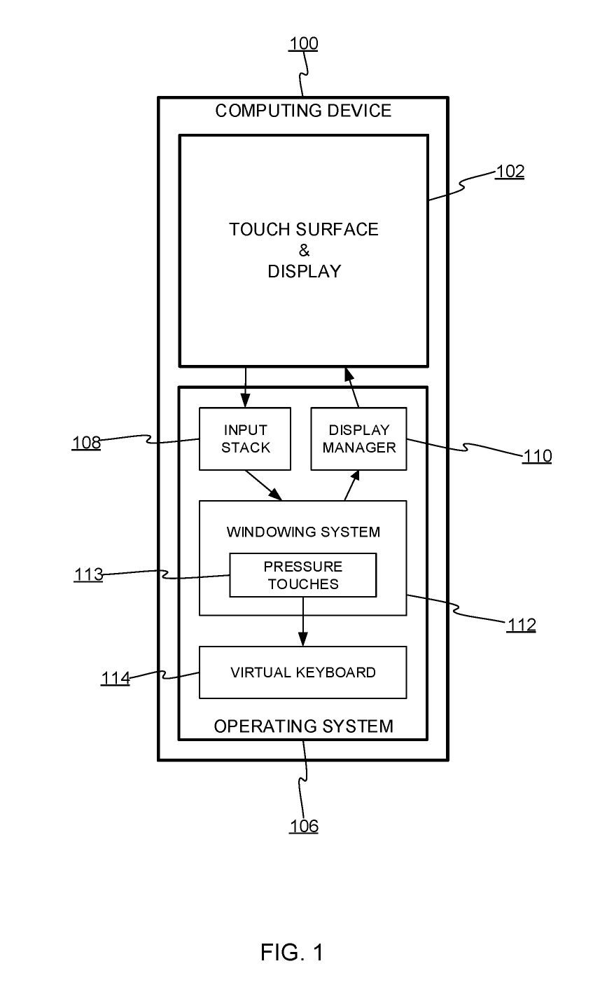

FIG. 1 shows a computing device 100 configured to provide a user interface on a display 102. The display 102 has touch and pressure sensing capabilities. An operating system 106 includes an input stack 108, a display manager 110, and a windowing system 112. The input stack 108 includes device drivers and other components that receive raw pressure points from the display 102 and convert them to a form usable by the windowing system 112. The windowing system 112 provides known functionality such as receiving pressure points and dispatching them as events 113 (pressure touches) to the software of corresponding windows (e.g., applications), generating the graphics for windows, etc. The display manager 110 manages the display of graphics generated by the windowing system 112 and may provide abstract display functionality for the windowing system 112 such as providing information about which displays are available and their properties.

The computing device 100 also includes a virtual keyboard 114. The virtual keyboard 114, or soft keyboard, is a module that receives touch events 113 or touch inputs. The virtual keyboard 114 is a known type of software module, but modified or extended as described herein to use pressure features of touch inputs to control the outputs of the virtual keyboard 114. In some embodiments, the virtual keyboard 114 is part of the operating system 106 and/or the windowing system 112. In these embodiments, the virtual keyboard 114 may be invocable in any context where letters, icons, or any symbols of a written language are to be inputted, e.g., in association with applications' text input areas, input areas of graphical user shells, etc. That is, the virtual keyboard 114 functions as a physical keyboard by responding to touch inputs by generating key-type events or messages that are dispatched and passed through the ordinary event-handling chain. As used herein, “text” refers to all the types of symbols that virtual keyboards can be used to input, e.g., alphanumeric characters, emoji, punctuation, and so forth. In other embodiments, the virtual keyboard 114 is implemented as an element of an application and operates within the scope of its application. The techniques described herein for incorporating pressure features of touch inputs are applicable for any type of virtual keyboard implementation.

The breakdown of functionality of modules shown in FIG. 1 is only an example of one type of environment in which embodiments described herein may be implemented. The embodiments described herein may be adapted to any computing device that displays graphics and uses a pressure-sensitive touch surface. The term “touch” is used herein to describe points inputted by any physical implement including fingers, pens, styluses, etc.

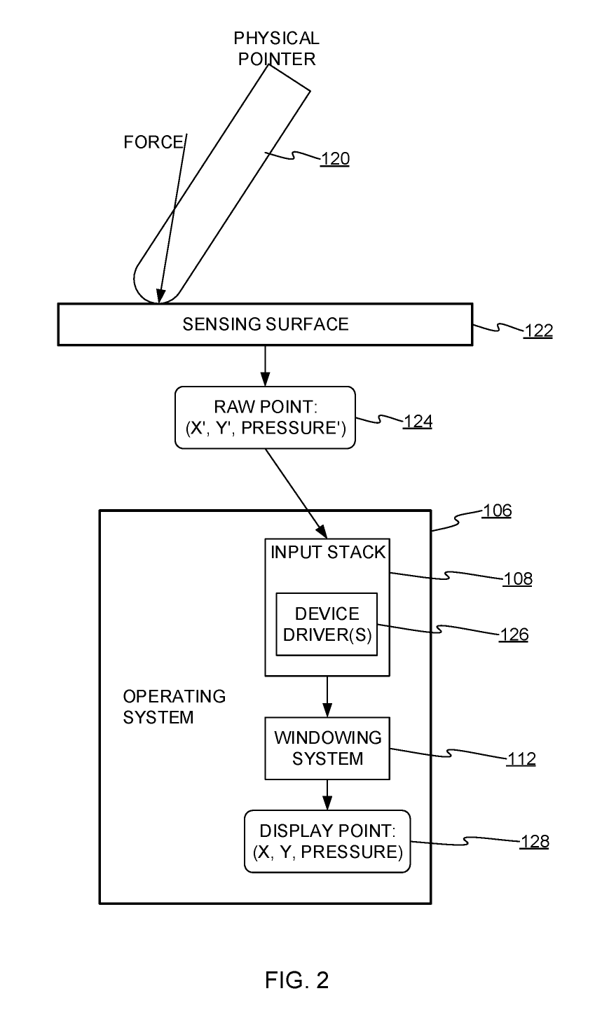

FIG. 2 shows additional details of the computing device 100. When a physical pointer 120 such as a finger or stylus contacts a sensing surface 122, the sensing surface 122 generates location signals that indicate the locations of the corresponding points of the sensing surface 122 contacted by the physical pointer 120. The sensing surface 122 also generates pressure signals that indicate measures of force applied to the sensing surface 122 by the physical pointer 120. Force or pressure sensing can be implemented based on displacement of the sensing surface, the shape formed by the contact points, heat, an array of pixel-scale pressure sensors, a sensor in a digital pen, etc. Any means of directly measuring, or indirectly estimating, the changing force of the physical pointer 120 will suffice. The term “pressure” is used herein to refer to pressure and/or force.

The sensing surface 122 (or stylus) outputs raw pressure points 124, each of which has device coordinates and a measure of pressure, for instance between zero and one. The input stack 108 receives the raw pressure points 124 which are passed on by a device driver 126. At some point at or between the hardware stack 108 and the windowing system 112 the raw pressure points are converted to display coordinates and outputted by the windowing system 112 as input events 128 (e.g., “up”, “down”, “move” events) to be passed down through a chain of responders or handlers from the windowing system 112 and possibly on to one or more applications or modules such as the virtual keyboard 114. In embodiments where the virtual keyboard 114 is a system user interface (UI) component, i.e., available for arbitrary applications, the pressure point input events 128 might bypass some of the ordinary event dispatching process.

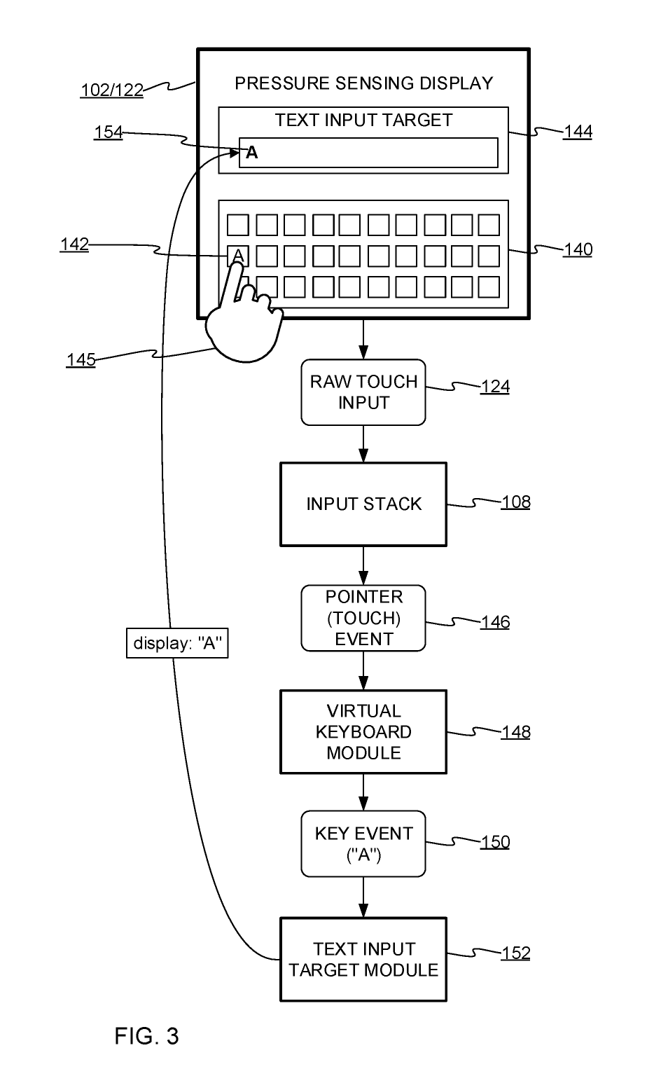

FIG. 3 shows context and data flow of the virtual keyboard 114. Initially, a graphic keyboard 140 is displayed on the display/surface 102/122. The graphic keyboard 140 has virtual keys 142. Generally, the virtual keyboard 114 is functionally linked to a text input area 144, perhaps being displayed responsive to an interaction with the text input area 144. When a physical touch is sensed, for instance by a hand 145, one or more raw touch inputs 124 are generated by the sensing surface 122. The raw touch inputs 124 pass through the input stack 108 and are translated to input events (“events” as used herein will also refer to messages, callbacks, and other forms of inter-process communication). For example, a pointer event 146 may be outputted in display space and typically includes a pressure measure, a two-dimensional display coordinate, a qualifier such as “up”, “down”, “move”, etc., a timestamp corresponding to the time the corresponding physical contact was sensed, etc.

Based on its coordinates falling within the display space of the graphic keyboard 140, the pointer event 146 is passed to a virtual keyboard module 148, which is the executable component of the virtual keyboard 114. The virtual keyboard module 148 implements the logic of mapping inputs to virtual key events such as key presses, key releases, key toggles, etc. The virtual keyboard module 148 may include a hierarchy of user interface elements such as containers or surfaces, the virtual keys 142, popup-controls, and other known components. The virtual keyboard module 148 may determine which virtual key the incoming pointer event 146 is associated with and, according to attributes of the pointer event 146 and perhaps also according to pointer events that are part of a same contact sequence (e.g., a stroke or dwell), the virtual keyboard module 148 decides what key event has occurred, if any. For example, if the pointer event 146 is a “touch down” event, the virtual keyboard module 148 might generated a “key press” event, or, if the pointer event 146 is a “touch up” event, a “key release” event might be generated by the virtual keyboard module 148. In some embodiments, activation of a key might be signaled by issuing a “key press” followed immediately by a “key release”. When a key event 150 is generated by the virtual keyboard module 148, the event is passed to the target module 152 that is displaying text input area 144. When the target module 152 determines that a key has been activated (i.e., a symbol has been inputted) the target module 152 may respond by displaying an inputted symbol 154, processing an inputted character, and so forth.

The virtual keyboard embodiments described herein may generally function as known virtual keyboards, but with enhancements to take advantage of pressure information to enable more efficient interactions. The virtual keyboard embodiments described herein may, as mentioned above, work with any types of symbols or symbol sets, e.g., different letters and punctuation for different written human languages, different graphic or iconic symbols, etc.

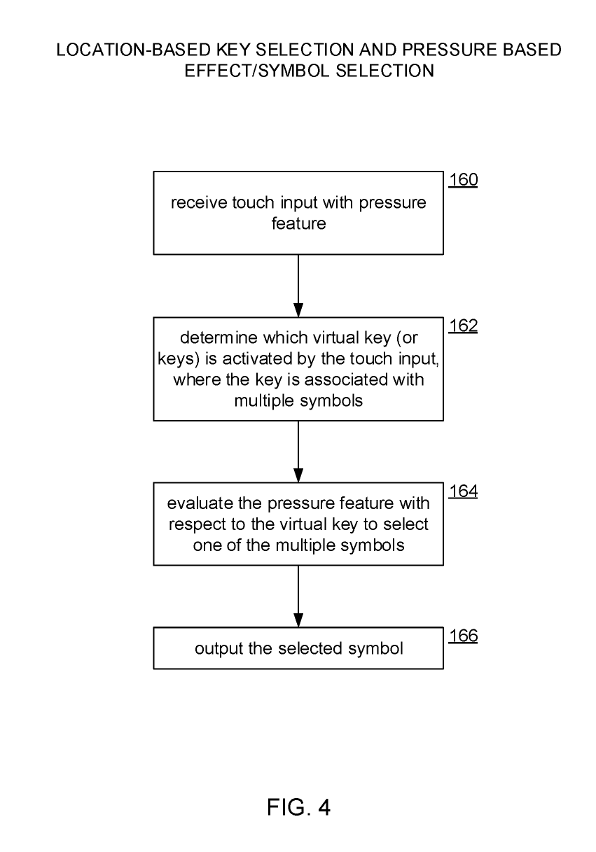

FIG. 4 shows a process by which a virtual keyboard 114 may consider pressure of touch inputs directed to the virtual keyboard. As described above, initially, at step 160 the virtual keyboard module 148 receives one or more touch input points, some or all of which include pressure measures corresponding to physical pressure applied to generate the touch input points.

At step 162, the virtual keyboard 114 may determine which virtual key 142 is targeted by the touch input. Generally, the display coordinates of the touch inputs determine which virtual key 142 is being touched. Some virtual keyboards may use statistical probabilities to resolve touch inputs that are close to more than one virtual key 142. Techniques for selecting virtual keys are described elsewhere and are not important to the embodiments described herein. Any known key selection technique may be used.

However the target virtual key 142 is selected by the touch input, the target virtual key 142 has a set of symbols associated therewith (the set may have only one symbol). As will be described, features of the key-selecting touch input may be used to specify one of the symbols in the set of associated symbols, and absent such features, by default, the touch input selects a default symbol of the targeted virtual key. For example, if the target virtual key represents the base-a symbol, the set of symbols associated with the target virtual key might include an uppercase “A” and a lowercase “a” (and possibly others). The default symbol might be the lowercase “a” symbol. The symbols in the associated set might be permutations such as diacritics (e.g., umlaut, grave accent, acute accent). The symbols might be transforms of the root symbol, for instance, different font sizes, different colors, different character sets, different font effects, or others. Multiple symbol sets can be associated with a virtual key. For practical purposes, sets of discrete symbol permutations and sets of symbol transformations that can produce them are functionally equivalent. As used herein, reference to a symbol permutation or variation refers to either a predefined symbol or a transform that can be applied to a root/base symbol to generate the symbol permutation or variation. The virtual keyboard module can use either or both techniques. For instance, a set of symbol transforms/permutations might include “capitalize”, “tilde”, and “underscore”.

Returning to FIG. 4, at step 164, one or more pressure measures of the touch input that selected the target virtual key are evaluated against a pressure condition. If the pressure condition is satisfied, then a symbol from the associated symbol set is selected by the touch input. If the pressure condition is not satisfied, then the base symbol of the key is selected by default. In either case, the virtual keyboard generates a key event for a symbol represented by the activated target virtual key. The key event might have a numeric code that identifies the symbol in a conventional character set and/or a symbol dictionary.

Notably, the same touch input that selects and activates the target virtual key is also able to specify a permutation symbol, i.e. a symbol that is a variation of or closely related to the target virtual key's base symbol. In some embodiments, this is done without the virtual keyboard displaying graphic representations of the associated permutation symbols. For instance, if the pressure condition is a threshold pressure measure (e.g., 0.5 on a scale from 0.0 to 1.0), then a tap with sufficient force (e.g. a force measure of 0.7) both activates the virtual key and signals the virtual keyboard to output a symbol from the associated symbol set rather than the base symbol. For example, if the “a” virtual key is firmly touched, then a capital “A” is outputted in a key event. If the “a” virtual key is touched without meeting the pressure condition, then the default base symbol is outputted.

In some embodiments, pressure-based selection can be implemented using virtual modifier keys that are already implemented by most virtual keyboards. Pressure features of touch inputs may map to different virtual modifier keys. For instance, a “firm” touch might map to a first virtual modifier key (e.g., “alt”) and a “hard” touch might map to a second virtual modifier key (e.g., “ctrl”). A “firm” touch combined with a long dwell might map to a third modifier key (e.g., a “command” key). The logic of the virtual keyboard module simulates activations of the virtual modifier keys according to the pressure features of the touch inputs. Activations may be simulated with simulated key events timed and ordered (relative to activation of the target virtual key) in ways appropriate for whichever virtual modifier key is selected. For instance, if a touch input starts with “firm” pressure, then the “alt” modifier may be selected and the virtual keyboard module may automatically simulate an “alt” down-key event before the target virtual key is activated and then simulate an “alt” up-key event after the target virtual key has been activated. Or, for capitalization, if a touch input ends with a “firm” pressure, then a “capitalize” virtual key might be simulated by triggering a “capitalize” key-down event, then a “capitalize” key-up event, before activating the target virtual key. Put another way, pressure features of touch inputs can be used to activate virtual keys that would not otherwise be activated by location of the touch inputs. A touch input might select a first target virtual key with its locations and select a second target virtual key with its pressure (regardless of the locations of the touch input). The first and second target keys might be treated as concurrent or sequential virtual key presses. Graphically indicating pressure-based activation of virtual modifier keys is optional.

In yet another embodiment, pressure features can be used to invoke functions of the virtual keyboard rather than (or in addition to) selecting symbols. For example, many virtual keyboards implement cut-and-paste functions that operate on a cut-and-paste buffer. Cut-and-paste functions can be mapped to various virtual keys (e.g., c-key for “cut” and p-key for “paste”). Pressure features of touch inputs directed to such virtual keys determine whether activations of the virtual keys trigger cut-and-paste functions or trigger symbol-selection. When one of those virtual keys is selected with an appropriate pressure feature, the function mapped to the virtual key is invoked. Other types of functions besides cut-and-paste functions may be invoked this way.

By using pressure measures for symbol selection, it is possible for a touch input to control which symbol permutation (of a virtual key selected by the touch input) is selected without having to display additional graphics or user interface elements and without requiring possibly slow and elaborate interactions by the user to specify permutations of a virtual key's symbol. For instance, there is no need to interact with a secondary user interface displayed in association with a selected virtual key (e.g., a pop-up palette of user-selectable permutation symbols). If the target virtual key has one symbol permutation accompanying the base symbol, then that symbol permutation can be efficiently and conveniently “typed” with the same speed as an ordinary tap of a virtual key. As will be described further below, non-pressure features of the key-selecting touch input can be combined with pressure-selecting features to enable a user to efficiently select from among many symbol permutations or to trigger other enhancements.

Although pressure-based virtual keyboard interactions can be implemented without the need to display supplemental graphics, graphics may nonetheless be displayed. Graphics portraying the associated permutation symbols may be displayed during a training period to help the user learn the pressure-based interactions. In some embodiments, interactive graphics may also supplement pressure-based techniques. For example, if a touch input satisfies a pressure condition then a radial or marking menu might be displayed over the target virtual key, with directions/sections representing respective permutation symbols. This approach may be useful when the number of permutation symbols varies from one virtual key to the next.

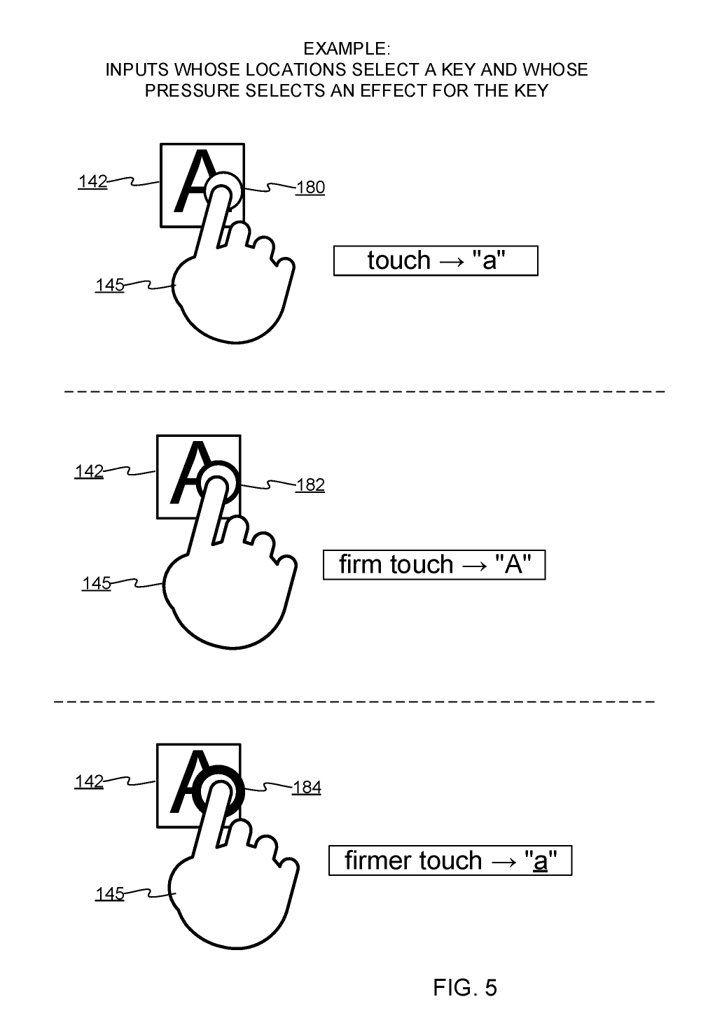

FIG. 5 shows examples of using pressure to select an effect or permutation of a symbol. A virtual key 142 is displayed and available for touch interaction. At the top of FIG. 5, the user touches the virtual key 142 with a light tap gesture 180. A pressure feature of tap gesture 180 is evaluated and determined not to meet a first pressure condition. Consequently, the activation of the virtual key 142 by the tap gesture 180 causes the virtual keyboard to output the default or base symbol for the virtual key 142, for example lowercase letter “a”.

As shown in the middle of FIG. 5, when a firm tap gesture 182 is received and associated with the virtual key 142, a pressure feature of the firm tap gesture 182 is evaluated and determined to satisfy the first pressure condition. As a result, a corresponding first permutation symbol associated with the virtual key 142 is selected and outputted by the virtual keyboard. For instance, a capital “A” key event is generated by the virtual keyboard.

The upper and middle portions of FIG. 5 represent an embodiment with one pressure condition and one permutation symbol. However, as shown in the lower part of FIG. 5, in another embodiment, more than one pressure condition may be used to provide pressure-based selection of different permutation symbols. The touch input may be tested against a second pressure condition if the first pressure condition is not met. When a firmer tap gesture 184 is received with a pressure feature of say 0.8. The pressure feature is tested against the first pressure condition (e.g., pressure between 0.4 and 0.7). The first pressure condition is not met and therefore the second condition is tested (e.g., pressure greater than 0.7). The second pressure condition is determined to be satisfied and a second symbol permutation is selected (e.g., lowercase “a” with an underscore).

In another embodiment, the first and second pressure conditions are not mutually exclusive and can together act as a form of multiplexor where the pressure conditions are inputs that select among available permutation symbols. For example, the first condition might be tested against a pressure feature of an initial portion of the touch input and the second condition might be tested against a pressure condition of an ending portion of the touch input. If two pressure conditions are provided, then there are four possible combinations of pressure signals to select four respective permutation symbols. For example, if both conditions are not met then the base symbol is selected. If only the first condition is met, then capitalization permutation is selected. If only the second condition is met, then an underscore permutation is selected. If both conditions are met then a capitalized underscore permutation is selected (e.g., “A”).

Determining whether a pressure condition is satisfied can be implemented in numerous ways. As discussed above, when the touch input is sensed, pressure can be sensed and associated with the touch input by including a pressure value with the one or more points of the touch input 200. Each point might have a pressure value, or each point at a given time interval, or every Nth point, etc. In one embodiment, a function maps the sequence of discrete pressure values to a summary pressure value by taking an average of the pressure values, perhaps giving weight to the initial pressure values. Alternatively, an average or maximum of only a first number (or percentage, or period) of pressure values may be used. Several summary pressure values might be computed for a same touch input. Any mapping, as a function of time or distance of corresponding input points, can be used to generate a single summary pressure value/feature or a sequence of summary pressure values/features.

A pressure condition for evaluating one or more pressure values may be as simple as a threshold value or range, a sequence of thresholds (as a function of time or distance) to be satisfied by respective pressure values (or pressure summaries), a rate or gradient of pressure change, a sustained pressure for a threshold period, a combination of such factors, etc. Generally, the sensed pressure values may be treated as a signal and any signal-processing techniques may be used to characterize the pressure signal and to evaluate traits of the signal to determine whether one or more pressure conditions are met. In some embodiments, only an initial portion (or ending portion) of a touch input's pressure values are evaluated and the pressures of input points inputted after the initial portion (or before the ending portion) do not affect the decision. Generally, any pattern of pressure-related features of a touch input can be correlated with the user's intent to select a particular symbol permutation or set of symbol permutations. The rate of pressure change can also influence the threshold values. For instance, pressing more quickly or with more duration reduce the threshold. The threshold may also be a deviation from the mean for that user (i.e., if a particular user tends to press harder all the time, the thresholds are raised to compensate).

The pressure conditions can be varied dynamically according to current conditions. For example, statistical spelling and grammar models, recently typed symbols, and/or the user's past behavior (in terms of words or symbols typed or in terms of touch and pressure behavior) can inform whether a particular type of permutation is likely and the pressure condition can be modified to favor selecting that permutation using pressure. For instance, if a user has typed “pie[space]” and then touched the “a” key, statistically it might be likely that “à la mode” is to follow and therefore the condition for pressure-selecting the grave accent for the “a” key might be relaxed.

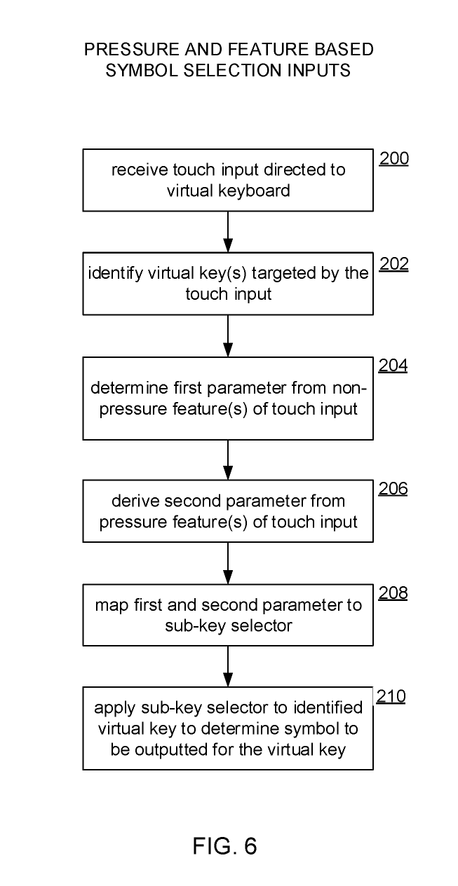

FIG. 6 shows a process for using both a pressure feature and non-pressure feature of a virtual keyboard touch input. At step 200 a touch input is received by the virtual keyboard. At step 202, based on the location of the touch input a target virtual key is selected. At step 204 a first parameter of the touch input is derived from one or more non-pressure features of the touch input. For example, a direction, duration, geometric feature, dwell time, or other attribute typically used for gesture recognition. The non-pressure features may be binary (e.g., a sufficient dwell time) or parameterized (e.g., several directions). At step 206 a second feature is derived from a pressure feature of the touch input. As discussed above, at step 208, the pressure-based feature is tested to see whether or which pressure condition is satisfied. At step 210 the first non-pressure parameter and the second pressure parameter are mapped to a permutation symbol associated with the virtual key identified at step 202. If no relevant parameters are present, the default symbol is selected. Finally, the virtual keyboard generates a key press/release event(s) for the selected symbol.

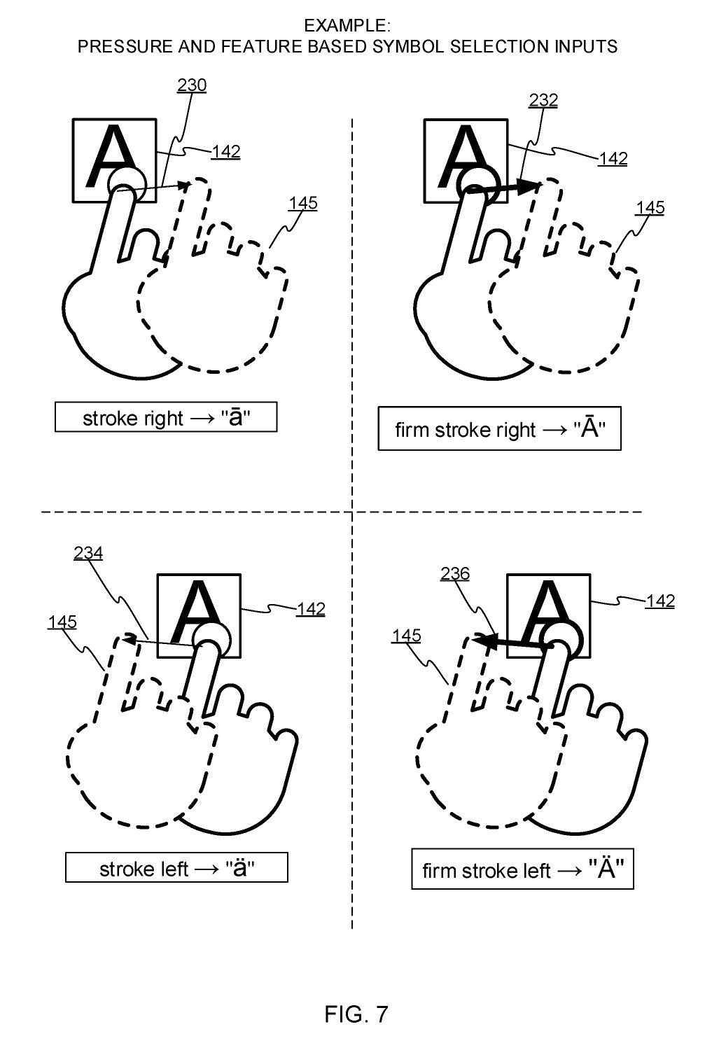

FIG. 7 shows examples of using pressure and non-pressure touch input parameters to select symbol permutations. In this example, pressure controls capitalization and direction controls a diacritic. At the upper left, a first stroke 230 is received and analyzed by the virtual keyboard. The first stroke 230 is determined to not satisfy a pressure condition and is determined to have a direction parameter of “rightward”. The pressure parameter is “false” and maps to “lowercase” and the direction parameter maps to a “hat” diacritic, thus a lowercase hatted “ā” is outputted by the virtual keyboard. At the upper right, a second stroke 232 is received and determined to satisfy a pressure condition (e.g., meets a pressure threshold) and is also determined to have a direction parameter of “rightward”. The pressure parameter is “true” and maps to “uppercase” and the direction parameter is “rightward” which maps to the “hat” diacritic. Thus, the virtual keyboard outputs an uppercase hatted “Ā”. At the lower left, a third stroke 234 is received and analyzed. In this case, the direction parameter is “leftward”, which maps to the “umlaut” diacritic. The pressure parameter is “false”, which maps to “lowercase”; the virtual keyboard generates a lowercase umlaut “ä”. At the lower right, a fourth stroke 236 is received. The pressure parameter thereof is determined to be “true” and the direction parameter is “rightward”. The combined parameters map to an uppercase umlauted “Ä” which the virtual keyboard then outputs.

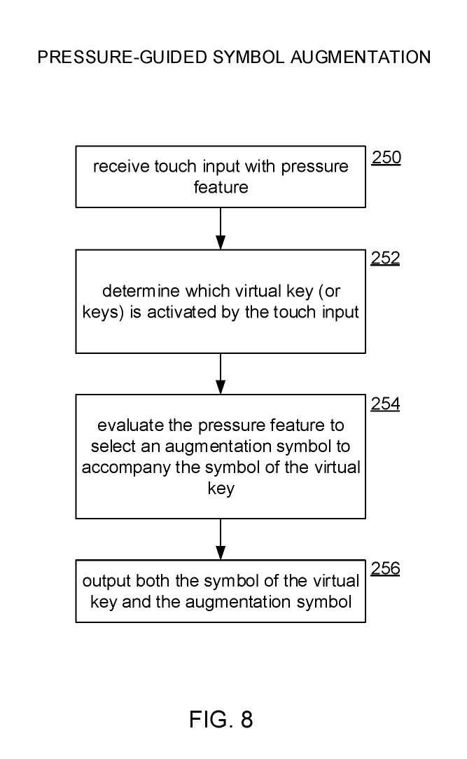

FIG. 8 shows a process for using pressure to select augmentation symbols that are added to text inputted via the virtual keys. An augmentation symbol is possibly a symbol not necessarily associated with the activated virtual key. For example, an augmentation symbol might be a punctuation mark such as a period or question mark. For discussion, a single augmentation symbol is discussed. However, and string of symbols may be used, for example a punctuation followed by a space or carriage return. Returning to FIG. 8, at step 250 a touch input with one or more pressure features is received by the virtual keyboard. At step 252 the touch input selects a target virtual key. At step 254 a pressure feature is evaluated to select an augmentation symbol. At step 256 the symbol of the selected virtual key is outputted as a key event, and then the augmentation symbol is outputted.

More than one pressure condition may be mapped to more than one respective augmentation symbol. For instance, if the touch input starts with a sufficiently firm pressure then a punctuation is selected and the touch input ends with a sufficiently firm pressure then then a space or carriage return is inserted. The pressure conditions may also be used in a sequentially conditional manner where the second pressure condition is evaluated only if the first pressure condition is satisfied. The technique described with reference to FIGS. 6 and 7 of combining other non-pressure touch input features may also be used. That is, non-pressure features of the touch input may contribute to selecting the augmentation symbol(s).

The techniques for selecting a permutation symbol and an augmentation symbol may be used together. In one embodiment, a direction feature (or some other non-pressure feature) and two pressure conditions are evaluated. If the first pressure condition is met, then the direction feature is used to select a permutation symbol according to whichever virtual key has been selected. If the second pressure condition is met, then the direction feature is instead used to select an augmentation symbol. In one embodiment, pressure-based symbol augmentation is restricted with respect to keys that correspond to the augmentation symbols. For example, when a “period” virtual key is pressure-activated, either no augmentation is available, or only non-punctuation symbols are selectable, e.g., a “space”, “hyphen”, “newline”, etc.

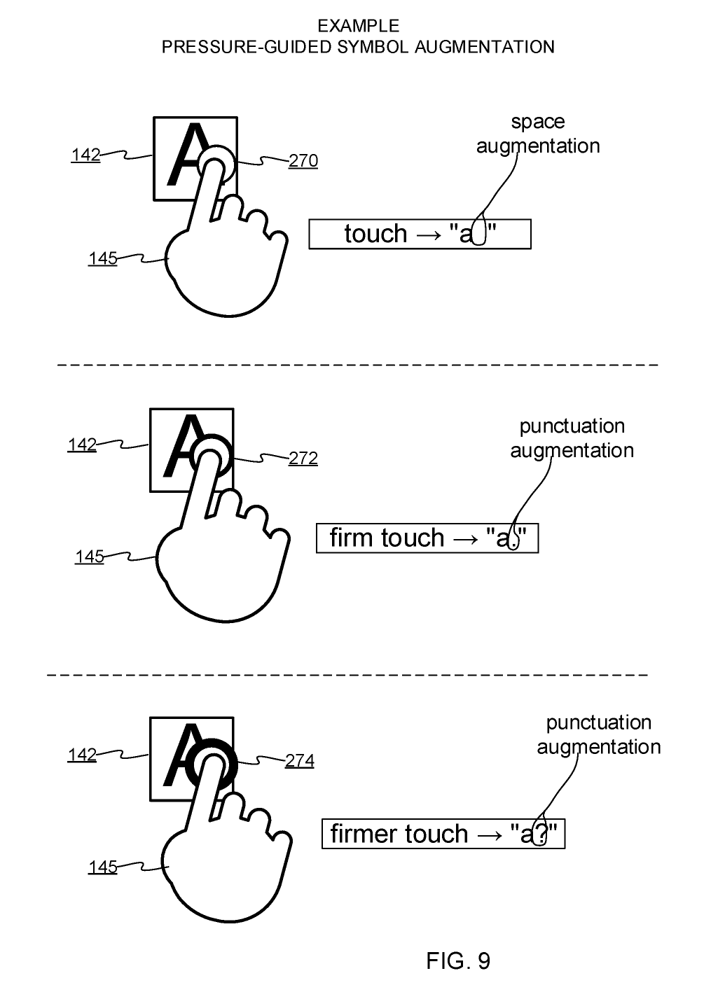

FIG. 9 shows examples of pressure-guided symbol augmentation. At the top of FIG. 9, a first touch input 270 is received and associated with a virtual key for the letter “a”. The activation of the virtual key causes the virtual keyboard to generate an “a” key event. In addition, satisfaction of a first pressure condition causes a “space” augmentation symbol to be outputted by the virtual keyboard. In the middle of FIG. 9, a second touch input 272 is received and similarly an “a” key event is generated. The second pressure condition is satisfied and a “period” augmentation symbol is outputted. In the lower part of FIG. 9, a third touch input 274 is handled. A third pressure condition is satisfied and the “a” symbol is followed by a “question mark” augmentation symbol. The pressure conditions may be implemented as described above. For example, the pressure conditions may correspond to respective durations of sufficient input pressure, different pressure ranges, a single pressure condition to indicate augmentation combined with a non-pressure parameterization feature to indicate an augmentation symbol, etc.

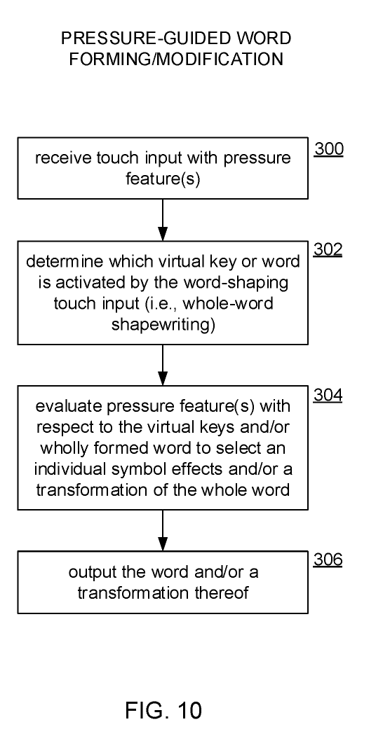

FIG. 10 shows a process for using pressure to guide how a virtual keyboard selects symbols when performing word-shaping. Word-shaping, also referred to as swipe-to-write, shape-writing, and gesture typing, involves tracing a continuous touch path on a virtual keyboard to intersect (or pass sufficiently near), in order, the letters of a desired word. Statistical language models and gesture features (e.g., inflections, dwells, loops) are used to select the most likely word along the traced path when the gesture ends. User data such as a customized dictionary may also be used to disambiguate words. Usually, a graphic line is displayed to indicate the path as it is being inputted. Turning to FIG. 10, at step 300 the virtual keyboard receives touch input with pressure features. The touch input may be at any stage of tracing a word on the virtual keyboard, for example, when a virtual key is intersected or when the touch input terminates. At step 302 the word or virtual key is determined, and at step 304 any of the techniques described above are used to select an augmentation and/or permutation symbol for the selected word or virtual key. At step 306 the word is outputted from the virtual keyboard. The technique may be particularly useful for capitalizing words, forming hyphenated words, and adding punctuation.

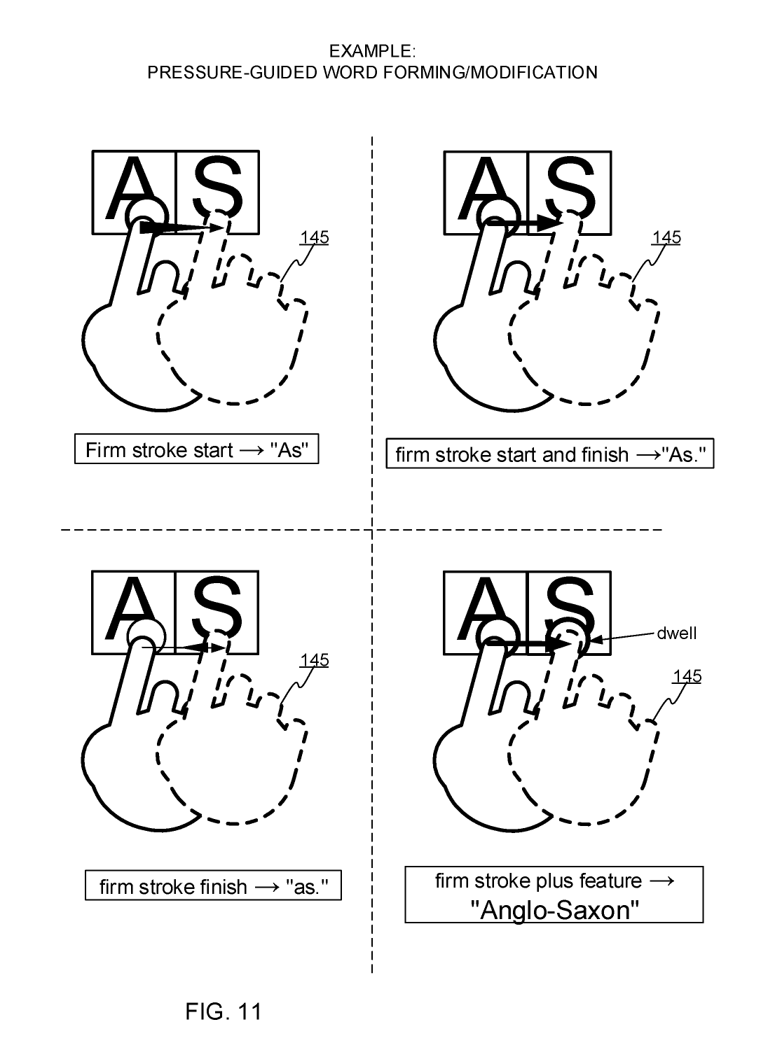

FIG. 11 shows examples of word-shaping with pressure-based interaction. In each example, the word “as” is traced. In the upper-left, the pressure of an initial portion of the gesture is tested. If, as in the example, the touch input meets the initial pressure condition then the traced word is capitalized; “As” is outputted when the word is completed. In the example at the upper-right, the touch input meets both an initial pressure condition and a finishing pressure condition, and thus the word is capitalized and an augmentation symbol—a period—is appended. In the lower-left the gesture only ends with a pressure feature and therefore the shaped word is augmented with a period. In the lower-right, the gesture is determined to begin and/or end with a pressure feature such as a sufficiently long dwell with sufficient pressure, which triggers a search of a dictionary for a graphic or phrase (e.g., an emoji) that matches the traced word, and the corresponding text is outputted by the virtual keyboard rather than the traced word. In the example at the lower-right of FIG. 11, the virtually typed symbols “AS” are mapped to the phrase “Anglo-Saxon”. This technique may also be used to select graphic symbols such as emoji.

In another embodiment, the pressure interaction techniques described above can be extended to user-defined macros or shortcuts starting with a pressure touch interaction on a particular key or ending with a pressure touch interaction preceded by a particular word (e.g. to expand the word to a custom phrase, to apply visual formatting to the word, or to replace it with an animation). This technique can be used for acronym/shorthand expansion. For instance, if the letters “brb” are traced, then typing of the phrase “be right back” may be simulated by the virtual keyboard module. In yet another embodiment, a pressure touch can be used to cycle between different input states needed to enter East Asian characters with a touch input method editor (e.g. switching between composition and candidate selection).

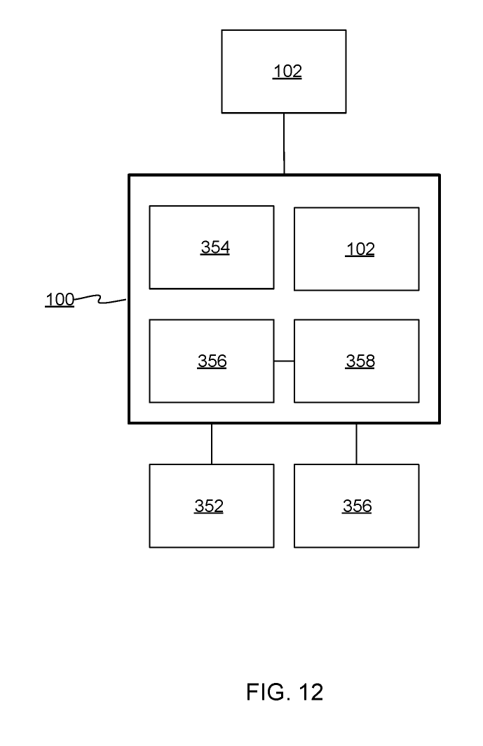

FIG. 12 shows details of the computing device 100 on which embodiments described above may be implemented. The technical disclosures herein will suffice for programmers to write software, and/or configure reconfigurable processing hardware (e.g., field-programmable gate arrays), and/or design application-specific integrated circuits (application-specific integrated circuits), etc., to run on the computing device 100 to implement any of the features or embodiments described herein.

The computing device 100 may have one or more displays 102, a network interface 354 (or several), as well as storage hardware 356 and processing hardware 358, which may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 356 may be any combination of magnetic storage, static memory, volatile memory, non-volatile memory, optically or magnetically readable matter, etc. The meaning of the term “storage”, as used herein does not refer to signals or energy per se, but rather refers to physical apparatuses and states of matter. The hardware elements of the computing device 100 may cooperate in ways well understood in the art of machine computing. In addition, input devices may be integrated with or in communication with the computing device 100. The computing device 100 may have any form-factor or may be used in any type of encompassing device. The computing device 100 may be in the form of a handheld device such as a smartphone, a tablet computer, a gaming device, a server, a rack-mounted or backplaned computer-on-a-board, a system-on-a-chip, or others.

Embodiments and features discussed above can be realized in the form of information stored in volatile or non-volatile computer or device readable storage hardware. This is deemed to include at least hardware such as optical storage (e.g., compact-disk read-only memory (CD-ROM)), magnetic media, flash read-only memory (ROM), or any means of storing digital information in to be readily available for the processing hardware 358. The stored information can be in the form of machine executable instructions (e.g., compiled executable binary code), source code, bytecode, or any other information that can be used to enable or configure computing devices to perform the various embodiments discussed above. This is also considered to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method performed by a computing device comprising storage hardware, processing hardware, and a pressure and touch sensing display, the storage hardware storing information to enable the processing hardware to perform the method, the method comprising:
displaying a virtual keyboard on the display, the virtual keyboard comprising a plurality of virtual keys;
receiving a touch input sensed by the display, the touch input comprising a pressure measure;
determining, based on the touch input, among the virtual keys, a target virtual key that is targeted by the touch input, wherein the target virtual key corresponds to a default symbol and a permutation symbol that is a permutation of the default symbol;
based on the pressure measure of the touch input, determining whether the touch input selects the default symbol or the permutation symbol and accordingly selecting either the default symbol or the permutation symbol; and
generating a key event comprising an indication of whichever symbol is selected by the selecting.

2. A method according to claim 1, wherein the determining comprises evaluating the pressure measure against a pressure condition, wherein if the pressure measure does not satisfy the pressure condition then the default symbol is selected, wherein if the pressure does satisfy the pressure condition then the permutation symbol is selected, and wherein the touch input corresponds to a sensed discrete continuous physical contact with the display.

3. A method according to claim 1, wherein the target virtual key is associated with a plurality of permutation symbols that are related to the default symbol, and wherein the touch input both activates the target virtual key and, based on its pressure measure, determines which of the permutation symbols are outputted in response to the activation of the target virtual key.

4. A method according to claim 1, further comprising determining a non-pressure feature of the touch input and selecting the permutation symbol from among a plurality of permutations symbols.

5. A method according to claim 4, wherein the non-pressure feature comprises a direction of the touch input, a shape of the touch input, a speed of the touch input, a dwell of the touch input, a length of the touch input, and/or a duration of the touch input, wherein the selected permutation symbol is selected based on the pressure measure and the non-pressure feature.

6. A method according to claim 1, wherein the virtual keyboard implements wordshaping, wherein the touch input intersects a plurality of the virtual keys, wherein a module of the virtual keyboard determines a word based on the plurality of virtual keys, and wherein the module modifies or transforms the word based on the pressure measure of the touch input.

7. A method according to claim 1, wherein the touch input comprises a plurality of pressure features, and the method comprises determining which symbol is selected by the touch input by determining whether a first pressure feature satisfies a first pressure condition and whether a second pressure feature satisfies a second pressure condition.

8. A method according to claim 1, wherein the selecting is performed without displaying additional corresponding user interface of the virtual keyboard.

9. A method according to claim 1, wherein the touch input does not cause the virtual keyboard to display a user interface element in association with the virtual key.

10. A computing device comprising:
storage hardware;
processing hardware;
a touch sensing display;
the storage hardware storing information to enable the processing hardware to perform a process, the process comprising:
displaying a virtual keyboard on the display, the virtual keyboard comprising virtual keys representing respective symbols;
receiving a touch input sensed by the display, the touch corresponding to a physical contact with the display, the touch input comprising a pressure feature corresponding to sensed pressure of the physical contact;
determining whether the pressure feature satisfies a pressure condition;
based on the determining, selecting a symbol represented by a virtual key; and
generating a key event indicating the selected symbol.

11. A computing device according to claim 10, the process further comprising:
determining which virtual key is activated by the touch input; and
generating a key event indicating a symbol represented by the activated virtual key, the generating based on the touch input activating the virtual key.

12. A computing device according to claim 11, wherein the touch input does not activate the virtual key that represents the selected symbol.

13. A computing device according to claim 10, the process further comprising, based on determining that the pressure feature satisfies the pressure condition, displaying a graphic representing the selected symbol.

14. A computing device according to claim 10, wherein the selecting the symbol represented by the virtual key comprises selecting, for the symbol, a diacritic, a size, a color, a graphic, a font effect, and/or a capitalization.

15. A computing device according to claim 10, the process further comprising determining whether the pressure feature of the touch input, and/or another pressure feature of the touch input, satisfies another pressure condition, and selecting the symbol based thereon.

16. A computing device according to claim 15, wherein the pressure condition comprises a first pressure threshold and the second pressure condition comprises a second pressure threshold.

17. A computing device according to claim 16, wherein the symbol is selected based on whether both of the pressure conditions are satisfied or is based on which one of the two pressure conditions is satisfied.

18. Storage hardware storing information configured to cause a computing device to perform a process, the process comprising:
executing a virtual keyboard that is displayed on a display of the computing device, the virtual keyboard comprising virtual keys;
receiving touch inputs directed to the virtual keyboard, the touch inputs comprising respective pressure components; and
activating the virtual keys according to the touch inputs, wherein each activation of a virtual key causes the virtual keyboard to generate a corresponding event or message, and wherein when a virtual key is activated by a touch input, which symbol is indicated in a correspondingly generated event or message is determined based on a pressure component of the touch input that activated the virtual key.

19. Storage hardware according to claim 18, wherein the virtual key represents a base symbol and the symbol comprises a capitalization of the base symbol.

20. Storage hardware according to claim 18, wherein the virtual keyboard implements a plurality of functions, and wherein the process further comprises invoking the functions based on the pressure components.
